(19) United States
(12) Patent Application Publication
(10) Pub. No.: US 2026/0127436 A1
(43) Pub. Date: May 7, 2026

(54) METHOD FOR GENERATING COMMAND SET FOR NEURAL NETWORK OPERATION, AND COMPUTING DEVICE FOR SAME

(71) Applicant: OPENEDGES TECHNOLOGY, INC., Seoul (KR)

(72) Inventor: Hyun EUN, Bucheon-si (KR)

(21) Appl. No.: 19/118,971

(22) PCT Filed: Oct. 5, 2023
(86) PCT No.: PCT/KR2023/015305

§ 371 Date: Apr. 7, 2025

(30) Foreign Application Priority Data
Oct. 6, 2022 (KR) 10-2022-0127743
Oct. 6, 2022 (KR) 10-2022-0127744

(51) Int. Cl. G06N 3/082

(52) U.S. Cl. CPC G06N 3/082

(57) ABSTRACT

Disclosed is a method for generating an NPU command, comprising the steps of: generating a p-th partial network having the same structure as a structure of a first network defined by a first group of layers included in a predefined neural network; determining, in a first memory included in another computing device, a p-th read address, which is a location of an address where a p-th partial input activation, which is data to be inputted to an uppermost layer of the p-th partial network, is stored; determining, in the first memory, a p-th write address, which is a location of an address where a p-th partial output activation, which is data outputted by a lowest layer of the p-th partial network, should be stored; and generating an NPU command on the basis of the p-th read address and the p-th write address.

### TECHNICAL FIELD

The present invention relates to a technology for generating commands to improve efficiency of a neural network operation and utilization efficiency of computing resources in a computing device including a neural processing unit NPU.

### BACKGROUND ART

This invention relates to a neural network operation executed in an NPU installed on a computing device. In FIG. 1, an example of a neural network operation is illustrated using a convolutional neural network (CNN) as an example.

FIG. 1 illustrates an operation structure of the CNN according to an embodiment. Hereinafter, a description will be given with reference to FIG. 1. First, convolution layers 52 may be generated by performing convolution operations using a plurality of kernels on input image data 51 stored in an internal memory. The generating of the convolution layers 52 may include performing a non-linear operation (e.g., ReLU, Sigmoid, or tanH) on a plurality of feature maps obtained as a result of performing the convolution operation. Next, pooling layers 53 may be generated by performing pooling for the convolution layers 52. Each convolution layer 52 may include data which can be represented in the form of an MAN matrix. Next, an array to be input to an internal neural network 54 may be generated by performing flattening on the pooling layers 53. Next, an output may be generated from the internal neural network 54 by inputting the array into the internal neural network 54.

All operation processes distinguished from each other illustrated in FIG. 1 may be considered to be different layers. In addition, the neural network according to the present invention may be considered to include all layers illustrated in FIG. 1, or the neural network may be considered to mean the internal neural network 54. FIG. 1 is an example to help understanding, and thus the scope of the neural network according to the present invention is not limited to the above-described content.

In the neural network, data can be operated and converted each time it encounters a layer while moving along the direction. This conversion and flow of data can be expressed in terms of a stream. The neural network may include a first layer and a second layer. In this case, if an output activation output from the first layer is input to the second layer as it is or after being further converted, the first layer may be referred to as a layer existing further upstream than the second layer, and the second layer may be referred to as a layer existing further downstream than the first layer. The terms upstream and downstream are introduced for the convenience of the description of the present invention.

A computing device, such as a desktop computer, a laptop computer, a smartphone, and a tablet, may be equipped with a neural processing unit NPU. The NPU may have a structure suitable for a neural network operation. In this case, in order for the NPU to execute the neural network operation, a controller in the NPU should execute predetermined commands for the neural network operation to control resources in the NPU. The commands may be stored in the NPU in a process of manufacturing the user device, or may be provided to the NPU even after the user device is manufactured.

When causing a predetermined neural network to be operated on the NPU, a size of input/output data of a specific layer defined in the predetermined neural network may be larger than the internal memory within the NPU. In this case, it is necessary to divide and process the input/output data into a size large enough to be stored in the internal memory.

In order to execute an operation corresponding to one specific layer, the NPU may obtain input data required for the operation, such as an input activation and other input data (e. g., weights, etc.) that to be input to the specific layer, from a memory e. g., DRAM) external to the NPU through a bus. Also, an output activation (output data) output by the one specific layer may be again provided to the memory external to the NPU through the bus. Since a write/read operation is performed in an external memory through a bus whenever an operation for each layer is performed, there is a problem that, as the number of layers in the neural network increases, more computing resources are consumed and the overall operation efficiency also decreases. This problem also occurs when dividing the input/output data into a size large enough to be stored in the internal memory and performing operations.

Since layers constituting a neural network may have a large number of input/output connection shapes between layers by a neural network manufacturer, it is difficult to perform effective operation division for all connection cases. As a result, for this reason, there is a problem that efficient hardware operation is difficult in terms of power and bandwidth.

In one implementation of a neural network operation method, data such as input tensors, layer parameters, weights, and biases are required for layer operations. A case where the size of the data is larger than the size of an internal storage (SRAM) of the NPU may occur. Also, an output tensor such as an output activation may be generated as a result of the layer operation, and a case where the size of the output tensor may be larger than the size of the internal storage of the NPU.

The output activation output from a specific layer may be written to an external storage of the NPU. In order to input the output activation to a next layer of the specific layer, the NPU should read the output activation written in the external storage and store the read activation in the internal memory. Therefore, in order to transfer an activation between layers, a write operation and a read operation using the bus may each occur once.

In an embodiment, a layer into which partial input activations generated by splitting the input activation by row-wise partitions are input may be a convolutional layer. In this case, the number of rows included in each partial input activation should be equal to or larger than the kernel size used for the operation of the convolution layer. In addition, the size of each partial input activation should be equal to or smaller than the size of the internal storage of the NPU. In addition, as the number of layers to be partitioned increases, the number of additional duplicate operations increases, and thus there is a problem that a read bandwidth and an operation amount may increase.

As described above, there is a problem that the read/write operation for the external storage inevitably occurs when layer partitioning is performed for the NPU operation.

### DISCLOSURE OF THE INVENTION

### Technical Problem

The present invention is intended to provide a technology for generating NPU commands that can reduce the bandwidth of a computing device by reducing the amount of data exchanged between the NPU and its external memory and also increase the operation efficiency of the NPU.

### Technical Solution

The commands executed by the NPU may be generated and provided by a developer who wants to provide an application using a predetermined neural network operation. The present invention includes content regarding a development tool that helps the developers to create the commands.

The present invention may use the concept of layer partitioning. The layer partitioning may mean a method of generating a layer in a form that can be operated in the NPU by defining a plurality of layers based on one layer in the cases described above when performing operations according to operation rules of the layers constituting the neural network using an operation device (a data operation unit) of the NPU.

In the present invention, a task of combining the plurality of partial output activations with each other to generate one output activation may be referred to as a layer concatenation (concat. layer) task. When the layer concatenation task is executed on the user computing device, the layer concatenation task may be performed by an operation in which the NPU writes the plurality of partial output activations to an external storage (e.g. DRAM) outside the NPU. That is, when all of the plurality of partial output activations are stored in a properly designated portion of the external storage, the one output activation may be regarded as having been generated.

According to a neural network operation method provided according to an aspect of the present disclosure, in order to reduce an amount of data transmitted using a bus between the NPU and the DRAM, one group composed of consecutive layers connected to each other among the layers constituting a neural network processed by the NPU may be defined. As a result, a communication bandwidth of a system including the NPU and the DRAM may be reduced. To this end, the entire neural network may be grouped into a predefined layer input/output structure which is advantageous for operation division.

A group provided according to an aspect of the present invention has at least three types. A first type of group may be referred to as an inverse-Y group, a second type of group may be referred to as a serial group, and a third type of group may be referred to as a residual group. The groups provided according to an aspect of the present invention are not limited to the above three types.

In this case, the network defined by the defined group may be partitioned into a plurality of partial networks, and the size of the internal memory included in the NPU may be used as a criterion for the partitioning.

In this case, among the layers constituting each of the groups, a start layer (an uppermost layer) and an end layer (a lowermost layer) may be determined according to a criterion for minimizing the consumption of hardware resources. Matters that should be considered to optimize the hardware resources include overlap activation size, weight reloading size, and DRAM input/output size.

According to an aspect of the present invention, a layer group may be created by grouping plurality of layers, and the created layer group may be partitioned. By doing this, the number of read/write operations for an external storage that occurs between execution time period of layers within a defined layer group can be reduced. As a result, the bandwidth for the NPU operation may be reduced. The layer group may be simply referred to as a group in this specification.

According to an aspect of the present disclosure, a grouping process for generating, by a developer computing device, a group composed of a plurality of layers constituting a neural network may be provided.

According to an aspect of the present invention, a group partitioning process, which is a process for partitioning, by a computing device for a developer, a group composed of a plurality of layers constituting a neural network, may be provided.

In this case, the grouping process may be executed first with respect to the group partitioning process.

To execute the grouping process, a layer grouping pattern, which is a pattern of consecutive layers capable of being grouped, may be predefined. When there is a part of the layers belonging to the neural network that is the same as the predefined layer group pattern, grouping of this part can be performed.

A structure of the neural network has already been designed before the method according to the present invention is executed and the neural network may not have undergone an optimization process for a specific NPU.

By the group partitioning process, a second network may be generated based on the first network defined by the group. The second network may be referred to as a partitioned network

The partitioned network may include P partial networks having the same network structure information as the first network, P slice layers generating P input activations to be input to the P partial networks, and a concatenation layer combining the P output activations output from the P partial networks.

Here, the network structure information of the first network may be information including layers that constitute the group (the first network), operation rules of the layers, and links indicating activation movement paths between the layers.

The group partitioning process may include the following steps.

In step S310, the developer computing may define one group composed of a plurality of layers constituting a neural network.

A rule defining the one group may be a rule used as a feature of the network structure information of the neural network.

In step S320, the developer computing device may define P slice layers that generate P partial input activations by dividing an input activation that to be input into the group.

In this case, a size of each of the partial input activations may be smaller than a size of a bank, in which the input activation is stored, of an internal memory of an NPU included in a user computing device.

In this case, the activations input to the slice layers may be the same. Also, the activations output from the slice layers may have different values.

In step S330, the developer computing device may define P partial networks, each of which receives the P partial input activations.

In this case, the network structure information of each partial network may be the same as the network structure information of the first network defined by the group.

In this case, the partial input activation input to each partial network may include only some data of the input activation to be input to the uppermost layer among the layers belonging to the group.

In step S340, the developer computing device can define a concatenation layer that combines the P partial output activations output by each of the P partial networks with each other.

In step S350, the developer computing device may define a plurality of links indicating activation movement paths between the P slice layers, the P partial networks, and the concatenation layer.

The partitioned network may be defined by defining the P slice layers, the P partial networks, the concatenation layer, and the plurality of links.

According to an aspect of the present invention, there may be provided a method of creating an NPU command, including generating, by a computing device, a p-th partial network having the same structure as a structure of a first network defined by a first group of layers included in a predefined neural network, determining, by the computing device, in a first memory included in another computing device, a p-th read address, which is a location of an address where a p-th partial input activation, which is data to be input to an uppermost layer of the p-th partial network, is stored, determining, by the computing device, in the first memory, a p-th write address, which is a location of an address where a p-th partial output activation, which is data output by a lowermost layer of the p-th partial network, is to be stored, and generating, by the computing device, an NPU command [p] including a first command set, a second command set, and a third command set. In this case, the first combination set includes commands for causing an NPU included in the other computing device to read the P-th partial input activation from the first memory based on the P-th read address and store the P-th partial input activation in an internal memory of the NPU. The second command set includes commands for causing the NPU to generate the p-th partial output activation based on the p-th partial input activation stored in the internal memory. Also, the third command set includes commands for causing the NPU to store the p-th partial output activation in the first memory based on the p-th write address.

In this case, the p-th partial input activation may be a part of an input activation to be input to an uppermost layer among the first group of the layers.

In this case, the first memory may be a memory provided outside the NPU, the p-th partial input activation may be configured to be transferred from the first memory to the internal memory of the NPU through a bus of the other computing device, and the p-th partial output activation may be configured to be transferred from the internal memory to the first memory through the bus.

In this case, the p-th partial output activation may be generated by performing operation on the p-th partial input activation stored in the internal memory based on operation rules of layers included in the p-th partial network.

In this case, the generating of the p-th partial network may include defining, by the computing device, the first group composed of a plurality of consecutive layers included in a predefined neural network, generating, by the computing device, structure information about the first network composed of a plurality of layers included in the defined first group and a plurality of links, and generating, by the computing device, the p-th partial network having the same structure as the first network. In this case, the structure information about the first network may be information about layers constituting the first group, operation rules of the layers, and links indicating activation movement paths between the layers.

In this case, the first group may include a plurality of layers, the uppermost layer may be a layer of the plurality of layers that receives an activation from outside the first group, and the lowermost layer may be a layer of the plurality of layers that provides an activation to outside the first group.

According to another aspect of the present invention, there may be provided a method of creating an NPU command, including generating, by a computing device, a partitioned network including a p-th partial network based on a first network composed of a first group of layers included in a predefined neural network (p is 1, 2, , and P), and generating, by the computing device, an NPU command [p] that is configured to be executed by an NPU included in another computing device with respect to the p-th partial network (p is 1, 2, , or P). The generating of the partitioned network may include defining, by the computing device, a p-th slice layer configured to receive an input activation to be input to the first group and output a partial input activation that is a part of the input activation (p is 1, 2, , and P), defining, by the computing device, a p-th partial network that receives a p-th partial input activation output from the p-th slice layer (p is 1, 2, , and P), defining, by the computing device, a concatenation layer that combines P partial output activations output from the P partial networks to each other, and completing, by the computing device, the partitioned network by defining a plurality of links indicating activation movement paths between the P slice layers, the P partial networks, and the concatenation layer.

In this case, the first group of the layers may be a plurality of consecutive layers included in the predefined neural network.

In this case, the p-th partial input activation may be a part of an input activation configured to be input to an uppermost layer among the first group of the layers. Also, the input activation may be restored using the first partial input activation to the P-th partial input activation.

In this case, a structure of the p-th partial network may be the same as a structure of the first network (p is 1, 2, , and P). Also, the generating of the NPU command [p] may include determining, by the computing device, in a first memory included in another computing device, a p-th read address, which is a location of an address where a p-th partial input activation, which is data to be input to an uppermost layer of the p-th partial network, is stored, determining, by the computing device, in the first memory, a p-th write address, which is a location of an address where a p-th partial output activation, which is data output by a lowermost layer of the p-th partial network, is to be stored, and generating, by the computing device, an NPU command [p] including a first command set, a second command set, and a third command set. Also, the first combination set may include commands for causing the NPU to read the P-th partial input activation from the first memory based on the P-th read address and store the P-th partial input activation in an internal memory of the NPU. The second command set includes commands for causing the NPU to generate the p-th partial output activation based on the p-th partial input activation stored in the internal memory. Also, the third command set may include commands for causing the NPU to store the p-th partial output activation in the first memory based on the p-th write address.

In this case, the first memory may be a memory provided outside the NPU. Also, the p-th partial input activation may be configured to be transferred from the first memory to the internal memory of the NPU through a bus of the other computing device, and the p-th partial output activation may be configured to be transferred from the internal memory to the first memory through the bus.

In this case, the generating of the p-th partial network may include defining, by the computing device, the first group composed of a plurality of consecutive layers included in a predefined neural network, generating, by the computing device, structure information about the first network composed of a plurality of layers included in the defined first group and a plurality of links, and generating, by the computing device, the p-th partial network having the same structure as the first network. In this case, the structure information about the first network may be information about layers constituting the first group, operation rules of the layers, and links indicating activation movement paths between the layers.

According to another aspect of the present invention, there may be provided a computing device including a storage unit and a main processor. In the storage unit, a program including commands that cause the main processor to execute generating a p-th partial network having the same structure as a structure of a first network defined by a first group of layers included in a predefined neural network, determining, in a first memory included in another computing device, a p-th read address, which is a location of an address where a p-th partial input activation, which is data to be input to an uppermost layer of the p-th partial network, is stored, determining, in the first memory, a p-th write address, which is a location of an address where a p-th partial output activation, which is data output by a lowermost layer of the p-th partial network, is to be stored, and generating an NPU command [p] including a first command set, a second command set, and a third command set is written. The first combination set includes commands for causing an NPU included in the other computing device to read the P-th partial input activation from the first memory based on the P-th read address and store the P-th partial input activation in an internal memory of the NPU. The second command set includes commands for causing the NPU to generate the p-th partial output activation based on the p-th partial input activation stored in the internal memory. Also, the third command set includes commands for causing the NPU to store the p-th partial output activation in the first memory based on the p-th write address.

According to another aspect of the present invention, there may be provided a computing device including a storage unit and a main processor. In the storage unit, a program including commands that cause the main processor to execute generating a partitioned network including a p-th partial network based on a first network composed of a first group of layers included in a predefined neural network (p is 1, 2, , and P), and generating an NPU command [p] that is configured to be execute by an NPU included in another computing device with respect to the p-th partial network (p is 1, 2, , or P) is written. The generating of the partitioned network includes defining, by the computing device, a p-th slice layer configured to receive an input activation to be input to the first group and output a partial input activation that is a part of the input activation (p is 1, 2, , and P), defining, by the computing device, a p-th partial network that receives a p-th partial input activation output from the p-th slice layer (p is 1, 2, , and P), defining, by the computing device, a concatenation layer that combines P partial output activations output from the P partial networks to each other, and completing, by the computing device, the partitioned network by defining a plurality of links indicating activation movement paths between the P slice layers, the P partial networks, and the concatenation layer.

According to an aspect of the present invention, there may be provided a neural network operation method that is executed in an NPU including an internal memory. The neural network operation method includes sequentially repeating a predetermined first process [p] from p=1 to p=P (p=1, . . . , P, P is a natural number of 2 or more). In this case, the first process [p] includes reading a partial input activation [1][p] from an external memory connected through a bus and storing the partial input activation [1][p] in a first bank of the internal memory, storing, in the first bank, a partial output activation [1][p] generated by performing an operation on, according to the operation rule of a layer [1], the partial output activation [1][p] stored in the first bank, sequentially repeating, from s=1 to s=L−1 (L is a natural number of 2 or more), a second process of storing a partial output activation [s+1][p], which is generated by performing an operation on a partial output activation [s][p] stored in the first bank according to the operation rule of a layer [s+1] connected to an output terminal of a layer [s], in the first bank, and writing the partial output activation [L][p] stored in the first bank to the external memory through the bus.

In this case, the partial input activation [1][p] may be a part of an input activation [1] to be input to the layer [1] of the neural network, or may be generated based on the part (p=1, . . . , P, P is a natural number of 2 or more).

In this case, the neural network operation method may further include, before the sequentially repeating of the first process [p], reading a weight [1] used for the operation rule of the layer [1] and a weight [s+1] used for the operation rules of the layer [s+1] (s=1, . . . , L−1) from the external memory through the bus and storing the weight [1] and weight [s+1] in a second bank of the internal memory. In this case, the output activation [1][p] may be generated based on the input activation [1][p] stored in the first bank and the weight [1] stored in the second bank, and the output activation [s+1][p] may be generated based on the output activation [s][p] stored in the first bank and the weight [s+1] stored in the second bank (s=1, . . . , L−1).

In this case, the repeating of the predetermined first process [p] may be executed based on a set of NPU commands executed by the NPU, an address where the partial input activation [1][p] is stored in the external memory may be included in the NPU command, and an address where the partial output activation [L][p] is to be stored in the external memory may be included in the NPU command.

In this case, an output activation composed of the partial output activations [L][p] (p=1, . . . , P) may be an input activation [L+1] input to a layer [L+1]. Also, the neural network operation method may further include, after the repeating of the first process [p], sequentially repeating a predetermined third process [q] from q=1 to q=Q (Q is a natural number of 2 or more). In this case, the third process [q] may include reading an input activation [L+1][q] from an external memory connected through a bus and storing the partial input activation [L+1][q] in a first bank of the internal memory, storing, in the first bank, an output activation [L+1][q] generated by performing an operation on, according to the operation rule of a layer [L+1], the output activation [L+1][q] stored in the first bank, sequentially repeating, from s=L+1 to s=M−1 (L is a natural number of L+2 or more), a fourth process of storing partial output activation [s+1][q], which is generated by performing an operation on an output activation [s][q] stored in the first bank according to the operation rule of layer [s+1] connected to an output terminal of layer[s], in the first bank, and writing the partial output activation [M][q] stored in the first bank to the external memory through the bus.

In this case, the partial input activation [L+1][q] may be a part of an input activation [L+1] to be input to the layer [L+1] of the neural network, or may be generated based on the part (q=1, . . . , Q, Q is a natural number of 2 or more).

In this case, the layer [1], the layer [s+1] (s=1, . . . , L−1), the layer [L+1], and the layer [s+1] (s=L+1, . . . , M−1) may be included in the neural network.

In this case, a partial output activation [s_{c}][p] may be generated based on a partial input activation [s_{c}][p] stored in the first bank and a weight [s_{c}] stored in the second bank of the internal memory, the operation rule of the layer [s_{c}] may be a convolution operation rule (s_{c}=1, . . . , or L), the input activation [1] may be a 3-dimensional tensor composed of a width dimension, a height dimension, and an input channel dimension, the weight [s_{c}] may be a 4-dimensional tensor composed of a width dimension, a height dimension, an input channel dimension, and an output channel dimension, a size of the input channel dimension of the input activation [1] may be the same as a size of the input channel dimension of the weight [s_{c}], and the partial input activation [1][p] may be a part of the input activation [1] obtained by being divided along the width dimension direction or the height dimension direction, or may be generated based on the part (p=1, . . . , P, P is a natural number of 2 or more).

According to another aspect of the present invention, an NPU device including an internal memory, a control unit, and a data operation unit may be provided. The control unit is configured to execute sequentially repeating a predetermined first process [p] from p=1 to p=P (p=1, . . . , P, P is a natural number of 2 or more) using the data operation unit. The first process [p] includes reading a partial input activation [1][p] from an external memory connected through a bus and storing the partial input activation [1][p] in a first bank of the internal memory, storing, in the first bank, a partial output activation [1][p] generated by performing an operation according to the operation rule of a layer [1], the partial output activation [1][p] stored in the first bank, sequentially repeating, from s=1 to s=L−1 (L is a natural number of 2 or more), a second process of storing a partial output activation [s+1][p], which is generated by performing an operation on a partial output activation [s][p] stored in the first bank according to the operation rule of layer [s+1] connected to an output terminal of layer [s], in the first bank, and writing the partial output activation [L][p] stored in the first bank to the external memory through the bus.

According to another aspect of the present invention, there may be provided a computing device including the NPU device, the bus, and the external memory.

### Advantageous Effects

According to the present invention, a technology for generating an NPU command that can reduce the amount of data exchanged between the NPU and an external memory, thereby reducing the bandwidth of a computing device, and also increasing the operation efficiency of the NPU can be provided.

### BRIEF DESCRIPTION OF THE DRAWINGS

FIG. 1 illustrates an operation structure of CNN according to an embodiment.

FIG. 2 illustrates a main structure of computing devices executing a method for neural network operation according to an embodiment of the present invention.

FIG. 3 illustrates a concept in which a user computing device obtains a command file executed by an NPU according to an embodiment of the present invention.

FIG. 4 illustrates an operation device, internal storage, and DMA of the NPU in the user computing device illustrated in FIG. 2.

FIG. 5 illustrates a structure of an input activation input to a layer of a neural network according to an embodiment of the present invention.

FIG. 6 is a diagram illustrating a neural network operation method using row-wise partitioning provided according to an embodiment of the present invention.

FIG. 7 illustrates the concept of a grouping process provided according to an aspect of the present invention.

FIG. 8a and FIG. 8b illustrate the concept of a group partitioning process that partitions a group composed of layers into a plurality of partitions according to an aspect of the present invention, respectively.

FIG. 8c is a flowchart illustrating a group partitioning process provided according to an embodiment of the present invention.

FIG. 9a, FIG. 9b, and FIG. 9c are flowcharts illustrating a method for creating a set of NPU commands to be provided by a developer computing device to a user computing device according to an embodiment of the present invention.

FIG. 10a is a conceptual diagram presented to help understand a neural network used in an embodiment of the present invention, and exemplifies a portion of a simple neural network structure.

FIG. 10b is a conceptual diagram presented to help understand a group defined by some layers included in a neural network according to an embodiment of the present invention.

FIG. 10C is a diagram for describing a network defined by a group defined according to an embodiment of the present invention and the structure of the network.

FIG. 10d is a diagram illustrating a method of defining a plurality of partial networks based on a network according to an embodiment of the present invention.

FIG. 10e is a diagram illustrating a correspondence between a network and a partial network.

FIGS. 11a, 11b, and 11c illustrate a method of performing neural network operations in the user computing device of FIG. 2 according to a comparative example.

FIGS. 12a, 12b, 12c, 13a, 13b, and 13c illustrate a method of performing neural network operations in the user computing device of FIG. 2 according to an embodiment of the present invention.

FIG. 14 is a diagram illustrating a neural network operation method provided according to an embodiment of the present invention.

FIGS. 15 and 16 are flowcharts illustrating a neural network operation method provided according to an embodiment of the present invention.

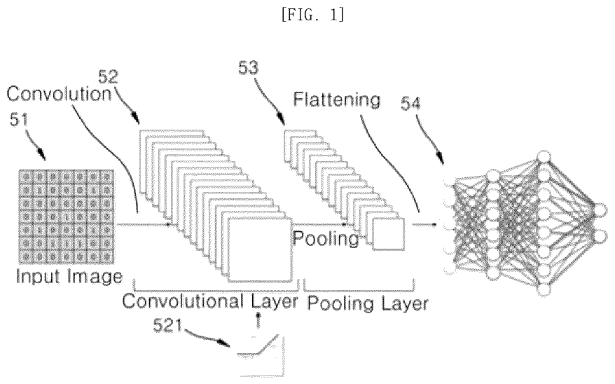

### MODE FOR CARRYING OUT THE INVENTION

Hereinafter, embodiments of the present invention will be described with reference to the accompanying drawings. However, the present invention is not limited to the embodiments described in this specification and may be implemented in various other forms. The terms used in this specification are intended to help understanding the embodiments and are not intended to limit the scope of the present invention. In addition, the singular forms used below also include plural forms unless the phrases clearly indicate the opposite meaning.

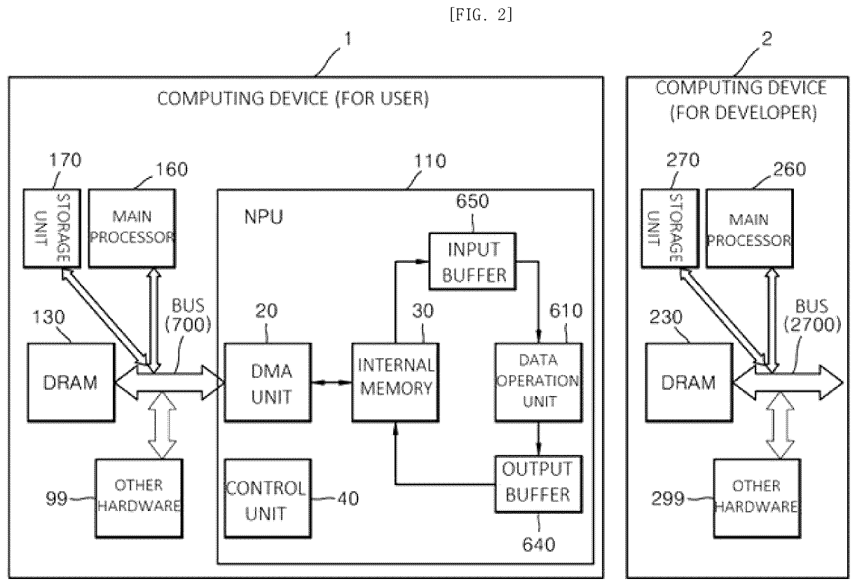

FIG. 2 illustrates main structure of computing devices executing a method for neural network operation according to an embodiment of the present invention.

A user computing device 1 shown in FIG. 2 may be a device such as, for example, a desktop computer, a laptop computer, a smartphone, and a tablet.

The computing device 1 may include a dynamic random access memory (DRAM) 130, an NPU 110, a bus 700 connecting the DRAM 130 and the NPU 110, and other hardware 99 connected to the bus 700, a main processor 160, and a storage unit 170.

The NPU 110 may also be referred to as a hardware accelerator.

In addition, the computing device 1 may further include a power supply unit, a communication unit, a user interface, and peripheral devices (not shown). The bus 700 may be shared by the NPU 110, other hardware 99, and the main processor 160.

The storage unit 170 may be integrally connected to the computing device 1, or may be detachably connected thereto.

The NPU 110 may include a direct memory access (DMA) unit 20, a control unit 40, an internal memory 30, an input buffer 650, a data operation unit 610, and an output buffer 640.

Some or all of data temporarily stored in the internal memory 30 may be provided from the DRAM 130 through the bus 700. In this case, in order to move the data stored in the DRAM 130 to the internal memory 30, the control unit 40 and the DMA unit 20 may control the internal memory 30 and the DRAM 130.

In this specification, the DRAM 130 may be referred to as an external memory.

The data stored in the internal memory 30 may be provided to the data operation unit 610 through the input buffer 650.

Output values generated by the data operation unit 610 performing an operation may be stored in the internal memory 30 through the output buffer 640. The output values stored in the internal memory 30 may also be written to the DRAM 130 under the control of the control unit 40 and the DMA unit 20.

The control unit 40 may comprehensively control the operation of resources within the NPU 110, such as the DMA unit 20, the internal memory 30, and the data operation unit 610.

In one implementation example, the data operation unit 610 may perform a first operation function during a first time period and a second operation function during a second time period. For example, the data operation unit 610 may perform the first operation function according to an operation rule of a first layer of the neural network during the first time period and the second operation function according to an operation rule of a second layer of the neural network during the second time period.

In FIG. 2, one data operation unit 610 is presented within the NPU 110. However, in a modified embodiment that is not illustrated, the data operation units 610 shown in FIG. 2 may be provided in plurality of numbers within the NPU 110 and may perform operations requested by the control unit 40 in parallel, respectively.

In one implementation example, the data operation unit 610 may output output data thereof sequentially according to a given order over time, rather than outputting it all at once.

A developer computing device 2 shown in FIG. 2 may be a device, such as, for example, a server, a desktop computer, and a laptop computer. The computing device 2 may include a DRAM 230, a bus 2700, and other hardware 299, a main processor 260, and a storage unit 270.

FIG. 3 illustrates a concept in which a user computing device obtains a command file executed by an NPU according to an embodiment of the present invention.

In this specification, the user computing device 1 may be referred to as a first computing device, and the developer computing device 2 may be referred to as a second computing device.

In one example, the user computing device 1 may obtain a command file to be executed by the NPU from the developer computing device 2 through a predetermined communication channel.

In another example, the user computing device 1 may obtain a command file to be executed by the NPU from the developer computing device 2 through a predetermined communication channel through a relay device 3. The relay device 3 may be a production device that is put into a production process of the user computing device 1.

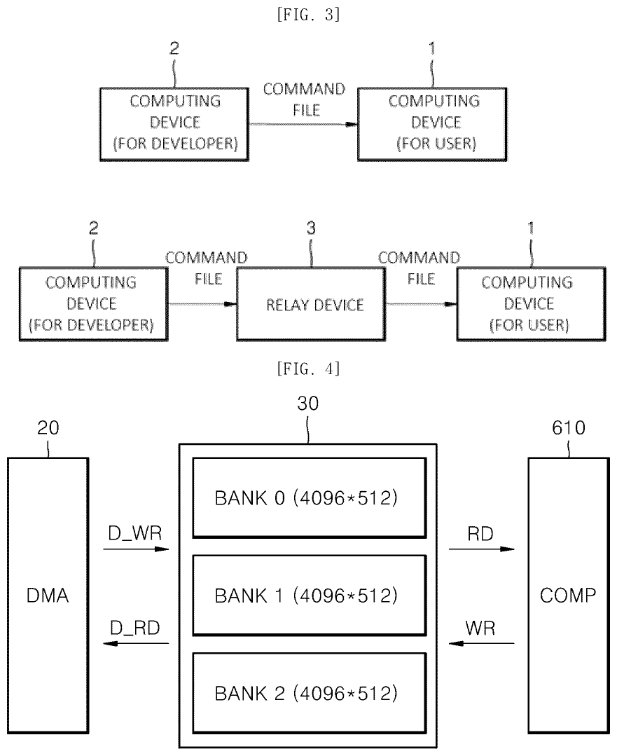

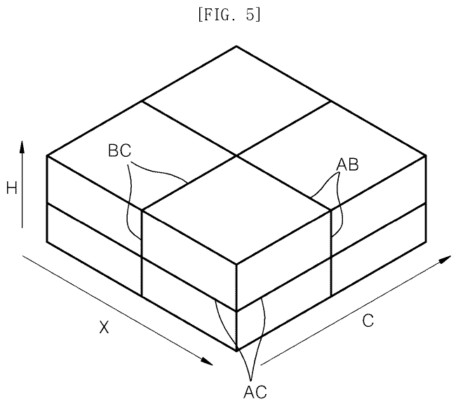

FIG. 4 illustrates an operation device COMP 610, internal storage SRAM (Bank 0 to 2) 30, and the DMA 20 of the NPU in the user computing device illustrated in FIG. 2. The DMA 20 brings data stored in an external storage (e. g., DRAM) through a bus and stores the data in the internal storage 30. The data stored at this time is data required for layer operation, such as input tensors (e.g., input activation) and layer parameters (e.g., weights for each layer). In this case, each of the data should be smaller than or equal to the size of each bank.

In FIG. 4, Bank 0 may be a place to store an input activation, Bank 1 may be a place to store a weight, and Bank 2 may be a place to store an output activation.

FIG. 5 illustrates a structure of an input activation input to a layer of a neural network according to an embodiment of the present invention.

As shown in FIG. 5, the input activation is a tensor having dimensions of C, H, and X. H is the height of the tensor, X is the width of the tensor, C is the depth of the tensor, and C is the number of channels of the tensor.

The input activation may be partitioned according to a channel-wise partitioning method in which the input activation is separated based on line AB of FIG. 5, a row-wise partitioning method in which the input activation is separated based on line AC of FIG. 5, or a column-wise partitioning method in which the input activation is separated based on line (BC) of FIG. 5.

In the neural network operation method provided according to an embodiment of the present invention, the input activation may be partitioned according to the row-wise partitioning method or the column-wise partitioning method.

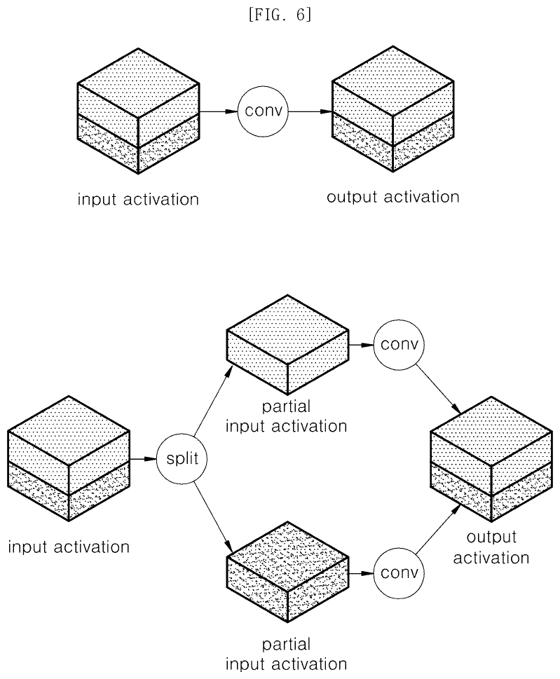

FIG. 6 is a diagram illustrating a neural network operation method using row-by-row partitioning provided according to an embodiment of the present invention.

At the upper part of FIG. 6, a diagram illustrating the concept of generating an output activation as a result of executing a convolution operation on an input activation expressed as a tensor having dimensions of C, H, and X is presented.

At the lower part of FIG. 6, a diagram illustrating the concept of generating the output activation by performing row-wise partitioning on an input activation expressed as a tensor having dimensions of C, H, and X to generate a first partial input activation and a second partial input activation, generating a first partial output activation generated as a result of executing a convolution operation on the first partial input activation and a second partial output activation generated as a result of executing a convolution operation on the second partial input activation, and generating the output activation by combining the first partial output activation and the second partial output activation is presented. In this case, a first weight corresponding to a first output channel may be convolved with the first partial input activation, and a second weight corresponding to a second output channel may be convolved with the second partial input activation.

According to the characteristics of the convolution operation, in order to restore the output activation by combining the first partial output activation and the second partial output activation, the first partial input activation should include all channels of the input activation, and the second partial input activation should also include all channels of the input activation. That is, when the total number of channels included in the input activation is Nc, the first partial input activation should also include data on Nc channels, and the second partial input activation should also include data on Nc channels. Therefore, in order for the operation method presented in the upper part of FIG. 6 and the operation method presented in the lower part to provide the same result, the input activation should be partitioned by the row-wise partitioning method or the column-wise partitioning method, not by the channel-wise partitioning method.

Although the row-wise partitioning method is illustrated in FIG. 6, each of the plurality of partial input activations generated using the column-wise partitioning method may include all channels of the input activation.

### Group Partitioning Process Executed by Developer Computing Device

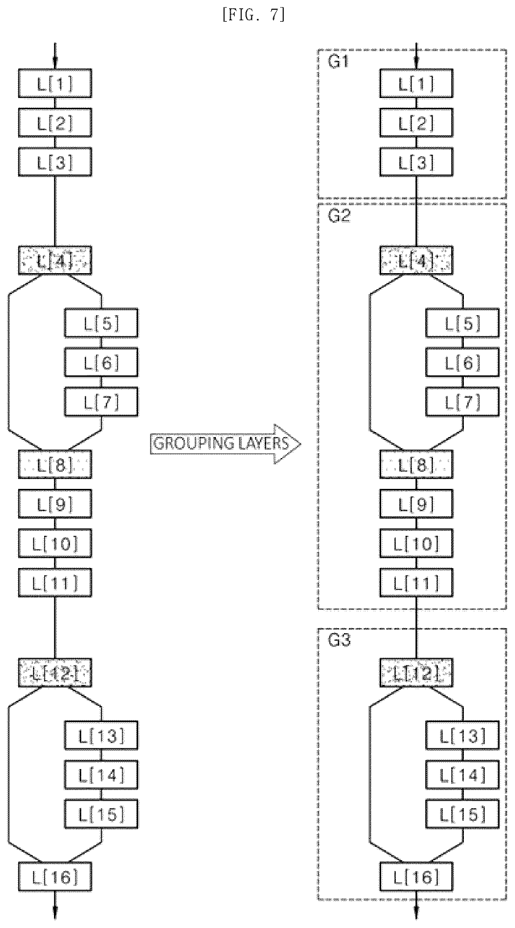

FIG. 7 illustrates a concept of a grouping process provided according to an aspect of the present invention.

The grouping process may be implemented in a developer computing device 2.

The left side of FIG. 7 illustrates some of layers constituting a given neural network. The neural network is for illustrative purposes only, and the structure of the neural network to which the present invention may be applied is not limited thereto.

In FIG. 7, layer L[4]and layer L[12] are layers that duplicate an activation input to them and output the activation twice. For example, layer L[4] provides the input activation to each of layer L[8] and layer L[5].

In FIG. 7, layer L[8] and layer L[16] are layers that add a plurality of input activations in an element-wise manner by element and output one output activation.

For example, layer L[8] adds an activation received from layer L[4] and an activation received from layer L[7] in an element-wise manner and outputs them. Therefore, a size of an output activation output by layer L[4] and a size of an output activation output by layer L[7] should be the same. Also, a size of an output activation output by layer L[8] is the same as the size of the output activation output by layer L[4] and the size of the output activation output by layer L[7].

The right side of FIG. 7 illustrates a concept of generating a group according to a predetermined rule according to an embodiment of the present invention based on the layers of the neural network presented on the left side of FIG. 7.

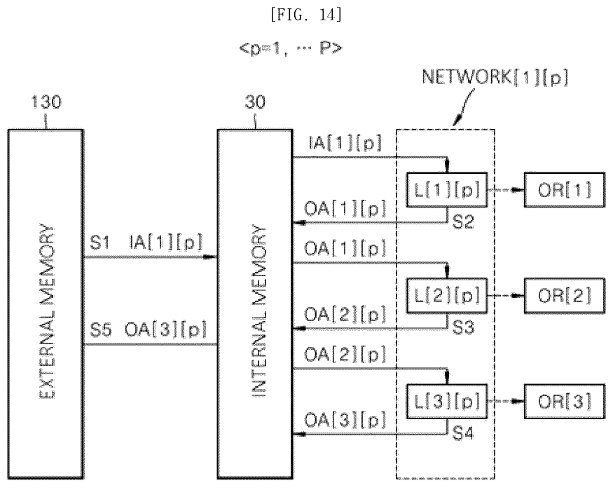

In an embodiment of the present invention, a plurality of layers may form one group. In the example of FIG. 14, layer L[1] to layer L[3] form a first group G1, layer L[4] to layer L[11] form a second group G2, and layer L[12] to layer L[16] form a third group G3.

In the first group G1, the uppermost layer and the lowermost layer are layer L[1] and layer L[3], respectively, in the second group G2, the uppermost layer and the lowermost layer are layer L[4] and layer L[11], respectively, and in the third group G3, the uppermost layer and the lowermost layer are layer L[12] and layer L[16], respectively.

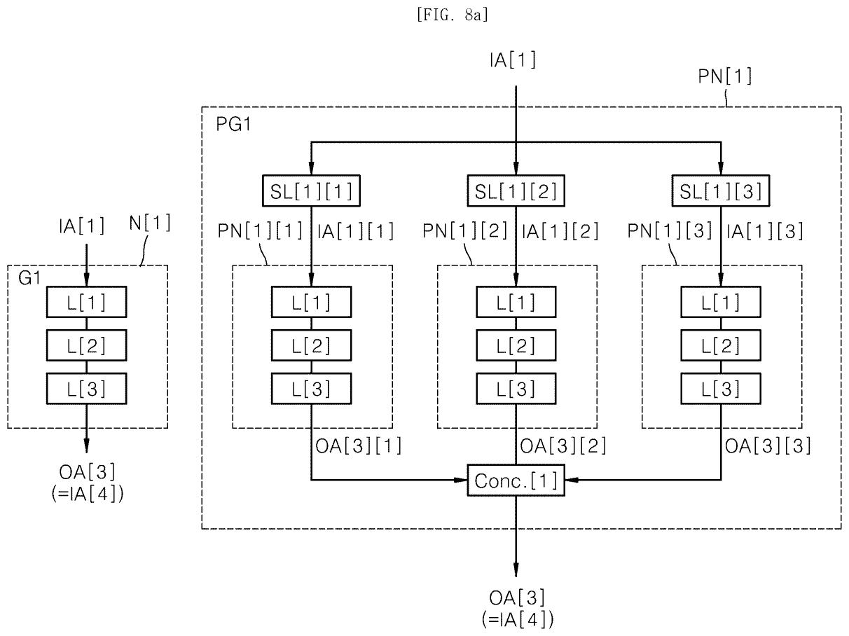

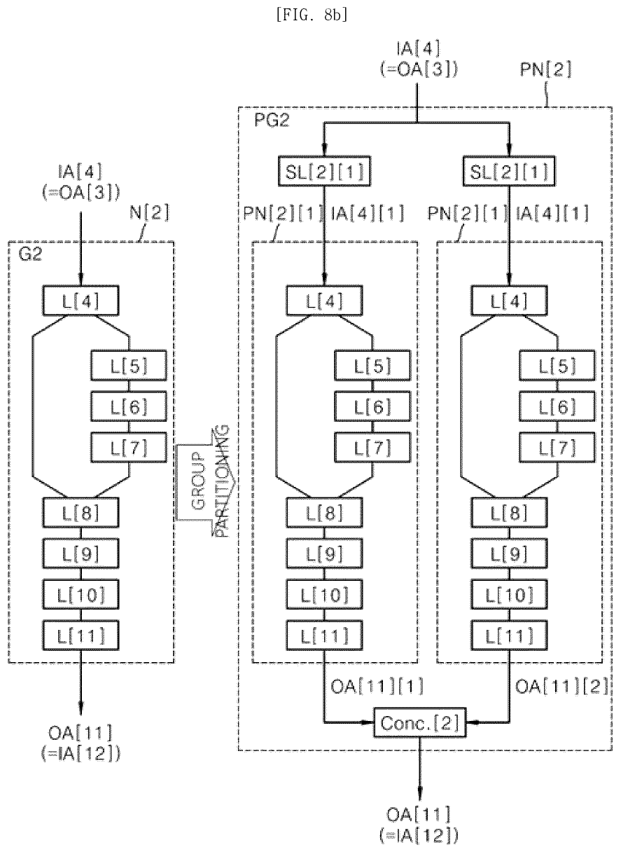

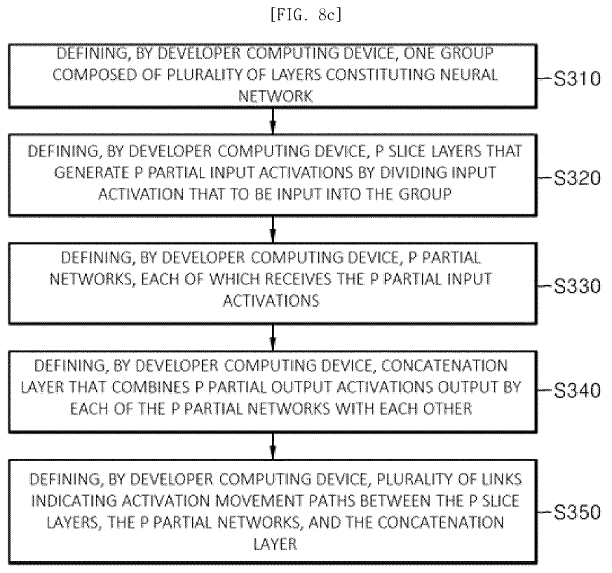

FIGS. 8a and 8b each illustrate the concept of a group partitioning process that partitions one group composed of layers into a plurality of partitions according to an embodiment of the present invention.

Hereinafter, FIGS. 8a and 8b may be collectively referred to as FIG. 8.

The group partitioning process may be implemented in the developer computing device 2.

Hereinafter, description will be made with reference to FIG. 8a.

FIG. Sa is an example of reconstructing the first group G1 of FIG. 7 into P partitions according to a partitioning rule according to an embodiment of the present invention. P is a natural number of 2 or more, and in the example of FIG. 8a, P=3. Therefore, the first group G1 may be converted into a first partitioned group PG1.

The developer computing device 2 may define one group G1 composed of a plurality of layers L[1] to L[3] that constitute a neural network.

A network N[1] defined based on the group G1 may be configured to include a plurality of layers included in the group G1 and links respectively connected to the plurality of layers.

The developer computing device 2 may define three slice layers SL[1][1] to SL[1][3] that divide an input activation IA[1] to be input to the group G1 to generate three (P=3) partial input activations IA[1][1] to IA[1][3], respectively.

In the symbol IA[s][p] representing the partial input activation, s is a value identifying a layer to which the partial input activation is to be input, and p is a value identifying a partition formed by the group partitioning process (p=1, . . . , P, P is the number of partitions).

In the symbol SL[g][p] representing the slice layer, g is a value identifying a group, and p is a value identifying a partition formed by the group partitioning process. For example, SL[1][2] means a layer that generates a partial input activation IA[1][1] provided to a first partial network PN[1][1], which is a first partition of a first group.

The developer computing device 2 may define three partial networks PN[1][1] to PN[1][3] that each receive the three partial input activations IA[1][1] to IA[1][3].

In the symbol PN [g][p] representing the partial network, g is a value that identifies a group, and p is a value that identifies a partition formed by the group partitioning process (p=1, . . . , P, P is the number of partitions).

In this case, network structure information of each of the partial networks PN[1][1] to PN[1][3] may be the same as network structure information of the network N[1] defined by the group G1. That is, the number of layers included in each network, an operation rule of each of the layers, and a connection relationship between the layers may be the same.

The developer computing device 2 may define a concatenation layer (Conc. [1]) that combines N partial output activations OA[3][1] to OA[3][3] output by the three partial networks PN[1][1] to PN[1][3], respectively, to generate one output activation OA[3].

In the symbol OA[s][p] representing the partial output activation, s is a value identifying a layer from which the partial output activation is output, and p is a value identifying a partition formed by the group partitioning process (p=1, . . . , P, P is the number of partitions).

In the symbol OA[s] representing the output activation, s is a value identifying a layer from which partial output activations that constitute the above output activation are output.

In the symbol Conc.[g] representing the concatenation layer, g is a value identifying a group.

The developer computing device 2 may define a plurality of links representing activation movement paths between the three slice layers, the three partial networks, and the the concatenation layer.

In this way, the developer computing device 2 may define the partitioned network PN[1] based on the network N[1] by defining the three slice layers, the three partial networks, the concatenation layer, and the plurality of links.

Hereinafter, description will be made with reference to FIG. 8b.

FIG. 8b is an example of reconstructing a second group G2 of FIG. 7 into P partitions according to the partitioning rule according to an embodiment of the present invention. In this example, P=2. Accordingly, the second group G2 may be converted into a second partitioned group PG2.

The developer computing device 2 may define one group G2 composed of a plurality of layers L[4] to L[11] that constitute a neural network.

A network N[2] defined based on the group G2 may be configured to include a plurality of layers included in the group G2 and links respectively connected to the plurality of layers.

The developer computing device 2 may define two slice layers SL[2][1] to SL[2][2] that divide an input activation IA[4] that should be input to the group G2 to generate two (P=2) partial input activations IA[4][1] and IA[4][2].

Here, the input activation IA[4] may be the same as the output activation OA[3] of FIG. 8a.

The developer computing device 2 may define two partial networks PN[2][1] and PN[2][2] that each receive the two partial input activations IA[4][1] and IA[4][2].

In this case, network structure information of each of the partial networks PN[2][1] to PN[2][2] may be the same as network structure information of the network N[2] defined by the group G2.

The developer computing device 2 may define a concatenation layer (Conc.[2]) that combines two partial output activations OA[11][1] and OA[11][2] output by the two partial networks PN[2][1] and PN[2][2], respectively, to generate one output activation OA[11].

The developer computing device 2 may define a plurality of links representing activation movement paths between the two slice layers, the two partial networks, and the concatenation layer.

In this way, the developer computing device 2 may define the partitioned network PN[2] based on the network N[2] by defining the two slice layers, the two partial networks, the concatenation layer, and the plurality of links.

As can be seen in FIG. 8a and FIG. 8b, a first topology representing the connection relationship between a plurality of layers constituting the first group G1 and a second topology representing the connection relationship between a plurality of layers constituting the second group G2 may be different from each other. However, regardless of the topology of a specific group, by defining a plurality of partial networks (e.g., PN[1][1], PN[1][2], and PN[1][3]) having the same structure information as the structure information of the network (e. g., N[1] ) defined by one specific group (e. g., G1), a partitioned group (e.g., PG1) corresponding to the specific group (e. g., G1) may be generated. That is, a partitioned network (e.g., PN[1]) corresponding to the network (e. g., N[1]) may be generated.

FIG. 8c is a flowchart illustrating a group partitioning process provided according to an embodiment of the present invention.

The developer computing device 2 may execute a grouping process that generates a group composed of a plurality of layers constituting a neural network. In order to execute the above grouping process, a layer grouping pattern, which is a pattern of consecutive layers that may be grouped, may be defined in advance. When there is a part of the layers belonging to the neural network that is the same as a predefined layer grouping pattern, grouping may be performed for this part.

Also, the developer computing device 2 may provide a group partitioning process, which is a process of partitioning a group composed of a plurality of layers constituting a neural network.

By the group partitioning process, a second network may be generated based on a first network defined by the group. The second network may be referred to as a partitioned network.

The partitioned network may include P partial networks having the same network structure information as the first network, P slice layers generating P input activations to be input to the P partial networks, and a concatenation layer that combines P output activations output from the P partial networks.

Here, the network structure information of the first network may be information including layers constituting the group (first network) , operation rules of the layers, and links indicating activation movement paths between the layers.

The group partitioning process may include the following steps.

In step S310, the developer computing device may define a group composed of a plurality of layers that constitute a neural network.

In step S320, the developer computing device may define P slice layers that divide input activations that to be input to the group to generate P partial input activations.

In step S330, the developer computing device may define P partial networks that each receive the P partial input activations.

In step S340, the developer computing device may define a concatenation layer that combines the P partial output activations that the P partial networks respectively outputs.

In step S350, the developer computing device may define a plurality of links that represent activation movement paths between the P slice layers, the P partial networks, and the concatenation layers.

The partitioned network may be defined by defining the P slice layers, the P partial networks, the concatenation layer, and the plurality of links.

### Method of Creating NPU Execution Command Executed by Developer Computing Device

In FIGS. 7 and 8, a concept of generating, by a developer computing device, a partitioned network based on a group composed of a plurality of layers is presented.

In an embodiment of the present invention, generating the partitioned network may be generating a data structure including objects and functions defining the partitioned network shown in FIG. 8.

The developer computing device 2 may create a command set for executing a neural network operation method for generating output activations that one group should output from input activations that are input to the one group composed of the plurality of layers, using the generated partitioned network. The command set may be transferred to the user computing device 1, and the command set may be executed on the user computing device 1.

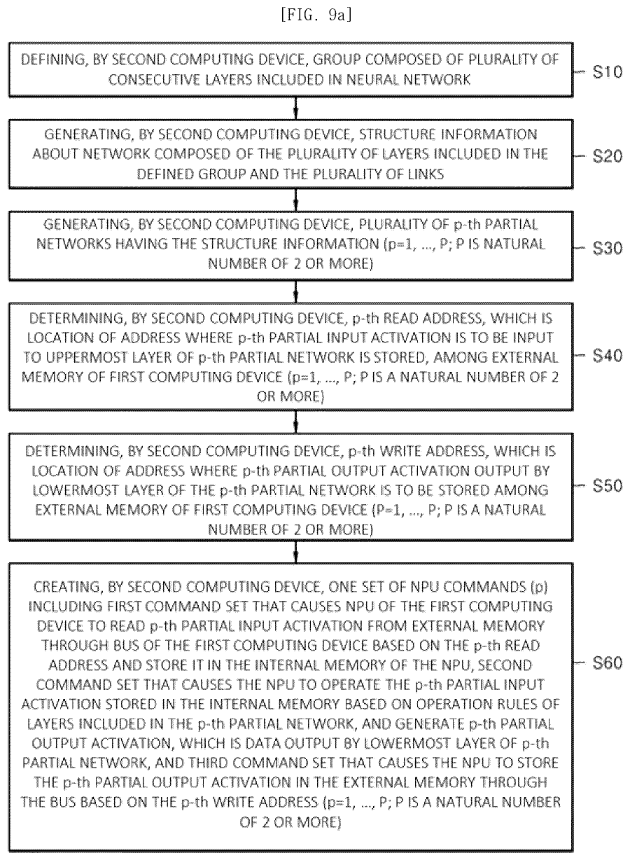

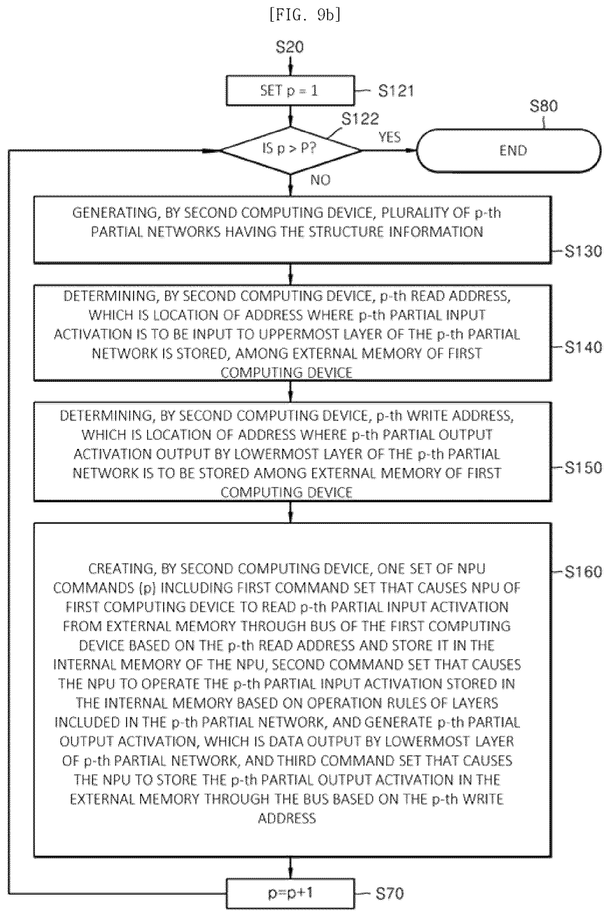

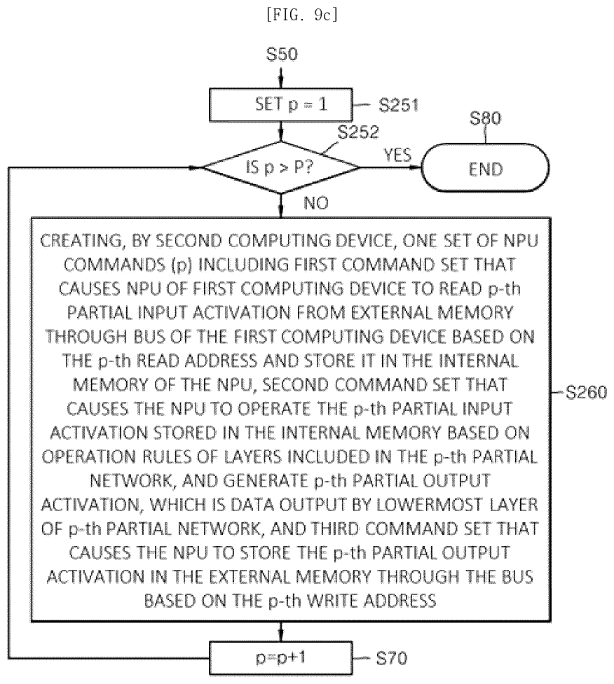

FIG. 9a is a flowchart illustrating a method for creating a set of NPU commands that the developer computing device 2 will provide to the user computing device 1 according to an embodiment of the present invention.

In step S10, the developer computing device 2 may define a group composed of a plurality of consecutive layers included in the neural network.

The layer may be, for example, the group G1 in FIG. 8a.

In this specification, the developer computing device 2 may be referred to as a second computing device.

In step S20, the second computing device 2 may generate structure information about a network composed of the plurality of layers included in the defined group and the plurality of links.

Here, each of the layers may be considered as a node constituting the network. Also, a structure of the network may be defined based on the connection relationship of the nodes and links included in the network. Also, the layers may be distinguished from each other based on the operation function executed by each layer and the location of each layer within the network. The structure of the network may be reproduced by the structure information.

In step S30, the second computing device 2 may generate a plurality of p-th partial networks having the same structure information as the structure information of the network (p=1, . . . , P; P is a natural number of 2 or more).

That is, a plurality of p-th partial networks having the same structure as the structure of the network may be generated.

In step S40, the second computing device 2 may determine a p-th read address, which is a location of an address where a p-th partial input activation to be input to an uppermost layer of the p-th partial network is stored, among the external memory 130 of the first computing device (user computing device) 1 (p=1, . . . P; P is a natural number of 2 or more).

Step S40 is associated with, for example, the function of the slice layer [1][1] of FIG. 8a. The slice layer [1][1] is a functional module that performs a function of generating and outputting a first partial input activation IA[1][1] from an input activation IA[1]. Here, the first partial input activation IA[1][1] is a part of the input activation IA[1]. However, the function may be executed as a simulation on the second computing device. In comparison to this, when the function is executed on the first computing device, this function corresponds to a task of reading data from a first read address, which is a location of an address where the first partial input activation IA[1][1] is stored among the external memory 130 of the first computing device 1.

In step S50, the second computing device 2 may determine a p-th write address, which is a location of an address where a p-th partial output activation output by a lowermost layer of a p-th partial network should be stored among the external memory 130 of the first computing device 1 (p=1, . . . , P; P is a natural number of 2 or more).

For example, in the example of FIG. 8a, the lowermost layer of the first partial network (PN[1][1] is a layer L[3], and the first partial output activation is OA[3][1].

In step S60, the second computing device 2 may create an NPU command p including a first command set, a second command set, and a third command set (p=1, . . . , P; P is a natural number of 2 or more).

The first command set causes the NPU 110 of the first computing device 1 to read the p-th partial input activation from the external memory 130 through the bus 99 of the first computing device 1 based on the p-th read address and store it in the internal memory 30 of the NPU 110.

The second command set causes the NPU 110 to operate the p-th partial input activation stored in the internal memory 30 based on the operation rules of the layers included in the p-th partial network, and generate the p-th partial output activation, which is data output by the lowermost layer of the p-th partial network.

The third command set causes the NPU 110 to store the p-th partial output activation in the external memory through the bus based on the p-th write address.

FIG. 9b is a modified embodiment from FIG. 9a, and illustrates a method of creating P sets of NPU commands in a situation where structure information of a network regarding a group composed of a plurality of consecutive layers is given.

After step S20 of FIG. 9a, step S121 of setting a value of a variable p to 1 may be executed.

In step S122, it may be determined whether the value of variable p is greater than a previously given value P. When it is determined that p>P is satisfied, the process may proceed to step S80 and end, and when p>P is not satisfied, the process may proceed to step S130.

Steps S130 to S160 of FIG. 9b correspond to steps S30 to S60 of FIG. 9a, respectively, and are executed based on the p value set at the current point in time.

In step S70, the value of variable p is increased by 1, and then the process may be returned to step S122.

FIG. 9c is another embodiment modified from FIG. 9a, and illustrates a method of creating P sets of NPU commands in a situation where structure information of a network for a group composed of a plurality of consecutive layers is given.

After step S50 of FIG. 9a, step S251 of setting the value of variable p to 1 may be executed.

In step S252, it may be determined whether the value of variable p is greater than a previous given value P. When it is determined that p>P is satisfied, the process may be moved to step S80 and ends, and when p>P is not satisfied, the process may be moved to step S260.

Step S260 of FIG. 9b corresponds to step S60 of FIG. 9a, and is executed based on the p value set at the current point in time.

In step S70, the value of variable p may be increased by 1 and then the process may return to step S252.

The created one set of NPU commands may be transmitted to the user computing device 1. The user computing device 1 may be configured to execute steps S800 and S900 described below using the one set of NPU commands.

Hereinafter, a neural network operation method executed in the user computing device 1 using the one set of NPU commands will be described in detail.

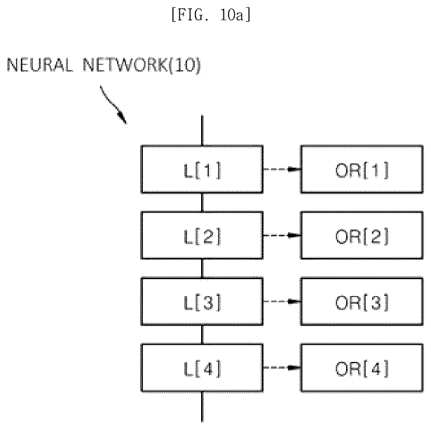

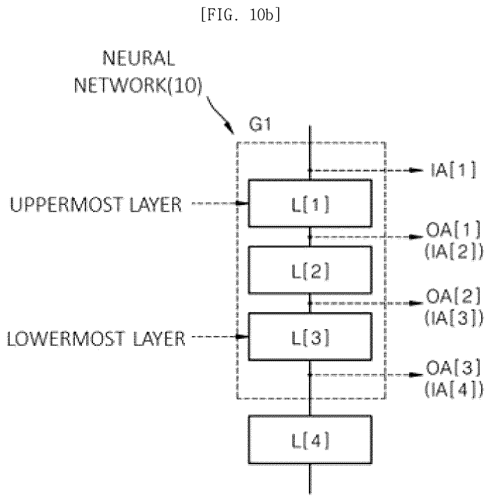

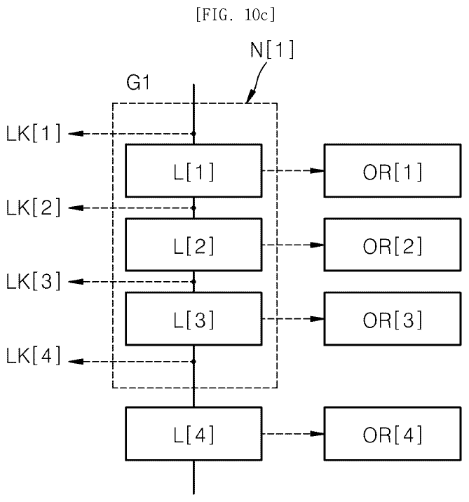

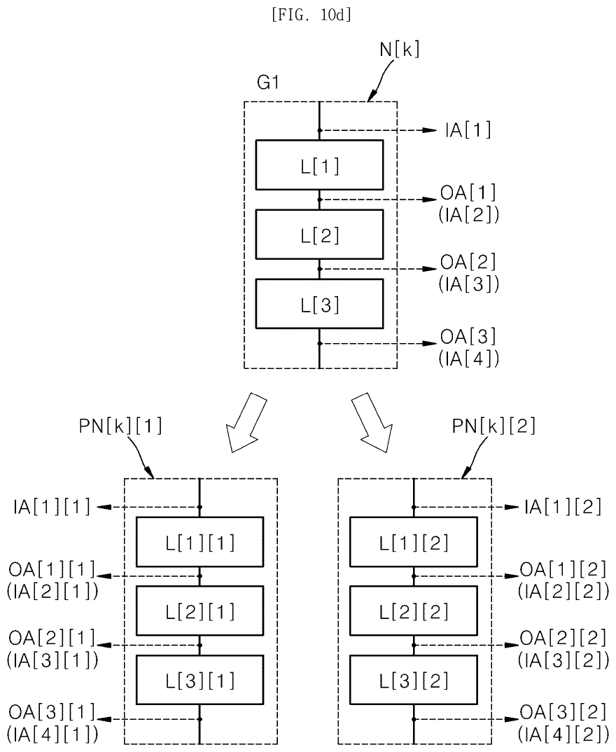

FIGS. 10a, 10b, 10c, 10d, and 10e, which will be described below, present the concepts of the neural network and layers shown in FIGS. 7, 8A, and 8B from a different perspective.

FIG. 10a is a conceptual diagram presented to help understand the neural network used in an embodiment of the present invention, and exemplifies a part of the structure of a simple neural network.

A neural network 10 illustrated in FIG. 10a is composed of four serially connected layers L[1], L[2], L[3], and L[4], and the operation rules OR of the layers are given as OR[1], OR[2], OR[3], and OR[4], respectively. The operation rule OR of each layer may mean a transfer function of input/output data of each layer.

FIG. 10b is a conceptual diagram presented to help understand a group defined by some layers included in a neural network according to an embodiment of the present invention.

The group defined according to an embodiment of the present invention may include a plurality of layers that are directly connected to each other. In FIG. 10b, an example of a first group G1 composed of a layer L[1], a layer L[2], and a layer L[3] is illustrated. In this case, within the first group G1, the layer L[1] becomes the uppermost layer and the layer L[3] becomes the lowermost layer. An activation input to the layer L[1] is referred to as an input activation [1]. An activation output from a layer L[s] is referred to as output activation OA [s] (s=1, 2, 3). The output activation OA[s] is an input activation [s+1] input to a layer L[s+1] (s=1, 2, 3).

FIG. 10c is a diagram for describing a network defined by a group according to an embodiment of the present invention and a structure of the network.

A network N[1] may be defined based on the first group G1.

The network N[1] may be configured to include a plurality of layers included in the first group G1 and links respectively connected to the plurality of layers. The link may mean a connection relationship between two layers mediated by an activation transferred between the two layers. That is, the link is a transmission path of an activation between the plurality of layers.

When an output activation OA[s] of a layer L[s] is provided to a layer L[s+1], the layer L[s] and the layer L[s+1] may be considered to be connected by a link identified by the output activation OA[s]. In this case, the link may be referred to as an outbound link of the layer L[s] and an inbound link of the layer L[s+1].

According to the example shown in FIG. 10c, the inbound link of the first layer L[1] is a first link LK[1], the inbound link of the second layer L[2] is a second link LK[2], the inbound link of the third layer L[3] is a third link LK[3], and the outbound link of the first layer L[1] is a second link LK[2], the outbound link of the second layer L[2] is a third link LK[3], and the outbound link of the third layer L[3] is a fourth link LK[4].

In this case, structure information [1] regarding the network N[1] may be defined.

The structure information [1] may be composed of some information of the structure information of the neural network 10.

In this specification, the term ‘neural network structure information’ means structure information of the neural network 10, and ‘structure information [k]’ means structure information of the network N[k].

The structure information [1] may include information identifying an inbound link connected to an arbitrary layer among the plurality of layers, and an outbound link connected to the arbitrary layer.

In addition, the structure information [1] may include information specifying an operation rule OR of the plurality of layers. For example, the operation rule of one layer among the plurality of layers may be defined as a convolution function, and the operation rule of another layer may be defined as a pooling function.

The structure information [1] of the network N[1] may include information that the network N[1] is composed of three serially connected layers L[1], L[2], and L[3], and information that the operation rules of the layers are OR[1], OR[2], and OR[3], respectively. In addition, the structure information [1] may include information that the inbound link of the first layer L[1] is the first link LK[1], the inbound link of the second layer L[2] is the second link LK[2], and the inbound link of the third layer L[3] is the third link LK[3], and that the outbound link of the first layer L[1] is the second link LK[2], the outbound link of the second layer L[2] is the third link LK[3], and the outbound link of the third layer L[3] is the fourth link LK[4].

FIG. 10d illustrates a method of defining a plurality of partial networks based on a network N[k] according to an embodiment of the present invention.

When P partial networks are defined based on the network N[k], each partial network may be expressed as a partial network PN[k][p] (p=1, . . . , P, where P is a natural number of 2 or more).

The example in FIG. 10d illustrates that two partial networks of a partial networks PN[1][1] and a partial network PN[1][2] are defined based on a network N[1].

FIG. 10e illustrates the correspondence between a network N[k] and a partial network PN[k][p].

Hereinafter, the description will be made with reference to FIG. 10d and FIG. 10e together.

In this specification, structure information of the neural network, structure information of the network N[k], and structure information of the partial network PN[k][p] may be referred to as neural network structure information, structure information [k], and structure information [k][p], respectively.

According to an embodiment of the present invention, structure information [k][p] of a partial network PN[k][p] is the same as structure information [k] of a network N[k]. However, a size of a partial input activation input to the partial network PN[k][p] is smaller than a size of an input activation input to the network N[k]d.

Therefore, the partial network PN[k][p] includes a layer L[s][p] corresponding to an arbitrary layer L[s] included in the network N[k]. In addition, the partial network PN[k][p] includes a link LK[s][p] corresponding to an arbitrary link LK[s] included in the network N[k].

In a preferred embodiment, the operation rule of the layer L[s][p] is the same as the operation rule of the layer L[s] (p=1, . . . , P).

In this case, the activation moved through the link LK[s][p] may be a part of activations moved through the link LK[s]. That is, an activation [s][p] moved through the link LK[s][p] may be a part of activations [s] moved through the link LK[s]. For example, in FIG. 10d, an input activation [1][1] moving through a link LK[1][1] may be a part of an input activation [1] moving through the link LK[1], and an input activation IA[1][2] moving through a link LK[1][2] may be the remaining part of the input activation [1] moving through a link LK[2].

In this case, the operation rule OR[s][p] of the layer L[s][p] may be the same as the operation rule OR[s] of the layer L[s]. Therefore, in the operation rule OR[s][p] of the layer L[s][p] and expressed, the index p can be deleted from and written as the operation rule OR[s].

Therefore, the layer L[s][p] may be considered to be the same as the layer L[s] (p=1, . . . , P).

In this case, in FIG. 10e, the size of the network N[1] may be larger than a size of a partial network PN[1][p]. Here, the size of the network may mean the size of the memory required to define the network and the size of the computing resources required to execute the function of the network.

In this case, the sizes of two partial networks of partial network PN[k][p1] and partial networks PN[k][p2] generated from a network N[k] may be the same or different from each other.

### Method of Executing a Neural Network Operation on User Computing Device

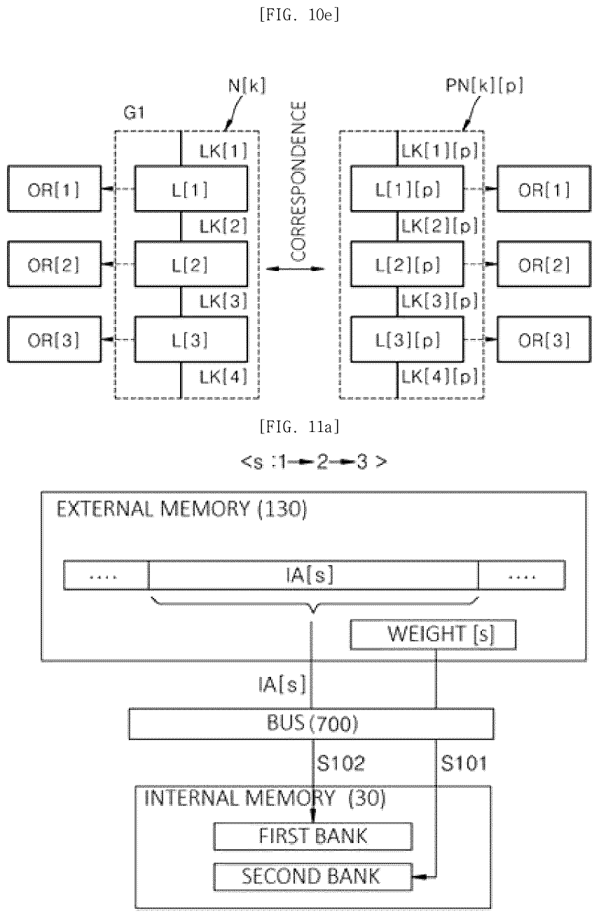

FIG. 11a, FIG. 11b, and FIG. 11c illustrate a method of performing a neural network operation on the user computing device of FIG. 2 according to a comparative example.

Hereinafter, FIG. 11a, FIG. 11b, and FIG. 11c may be collectively referred to as FIG. 11.

Hereinafter, in this specification and drawings, the symbol IA represents an input activation and OA represents an output activation.

Using FIG. 11, a process of generating an output activation OA[3] based on input activation IA[1] shown in FIG. 10B will be described.

In FIG. 11, a reference symbol s is presented, and steps S101 to S106 are presented.

When the reference symbol s is set to 1 and steps S101 to S106 are executed, the output activation OA[1] of FIG. 10b is generated and stored in the external memory 130.

Next, when the reference symbol s is set to 2 and steps S101 to S106 are executed, an output activation OA[2] of FIG. 10b is generated and stored in the external memory 130.

Next, when the reference symbol s is set to 3 and steps S101 to S106 are executed, an output activation OA[3] of FIG. 10b is generated and stored in the external memory 130.

Hereinafter, steps S101 to S106 will be described in detail.

In step S101, the control unit 40 and the DMA unit 20 may read a weight [s] from the external memory 130 through the bus 700 and store the weight [s] in a second bank of the internal memory 30.

In step S102, the control unit 40 and the DMA unit 20 may read an input activation IA[s] from the external memory 130 through the bus 700 and store the input activation IA[s] in a first bank of the internal memory 30.

In step S103, the control unit 40 may provide the input activation IA[s] stored in the first bank to the data operation unit 610.

In step S104, the control unit 40 may provide the weight [s] stored in the second bank to the data operation unit 610.

In step S105, the data operation unit 610 generates the output activation OA[s] based on the input activation IA[s] and the weight [s] according to the operation rule of the layer [s], and the control unit 40 may store the output activation OA[s] in the first bank.

In step S106, the control unit 40 and the DMA unit 20 may store the output activation OA[s] in the external memory 130 through the bus 700.

In this case, in the process of generating an output activation OA[3] based on the input activation IA[1], the input activation IA[s] and the output activation OA[s] move several times through the bus 700 (s=1, 2, 3).

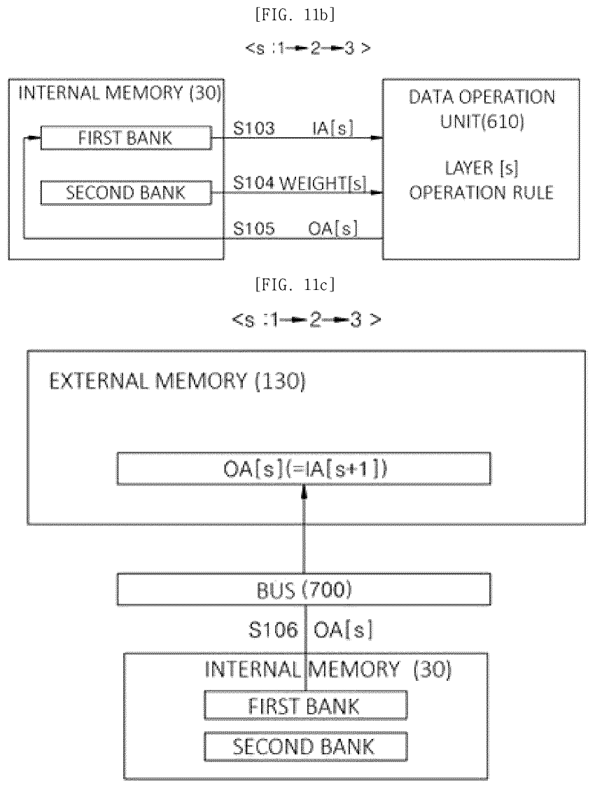

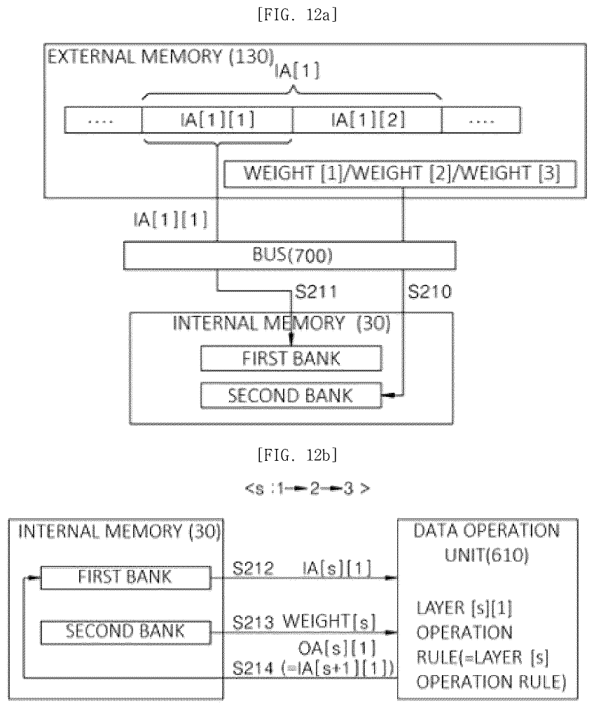

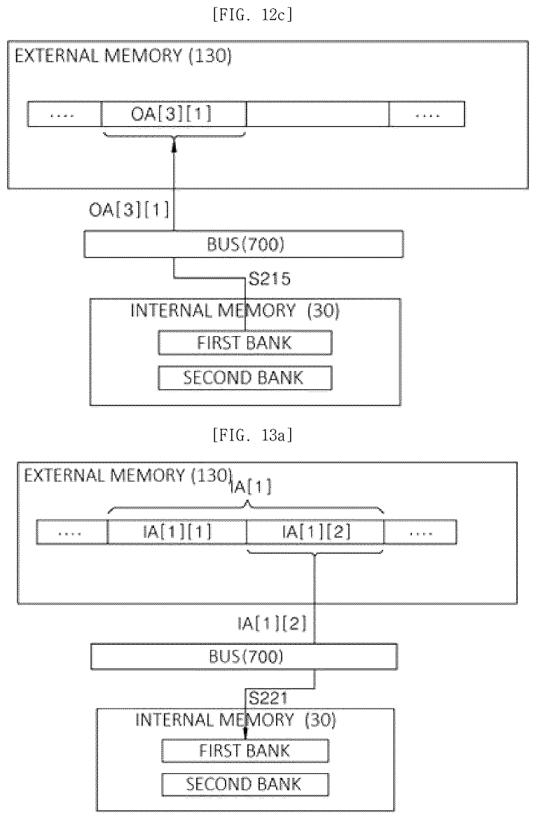

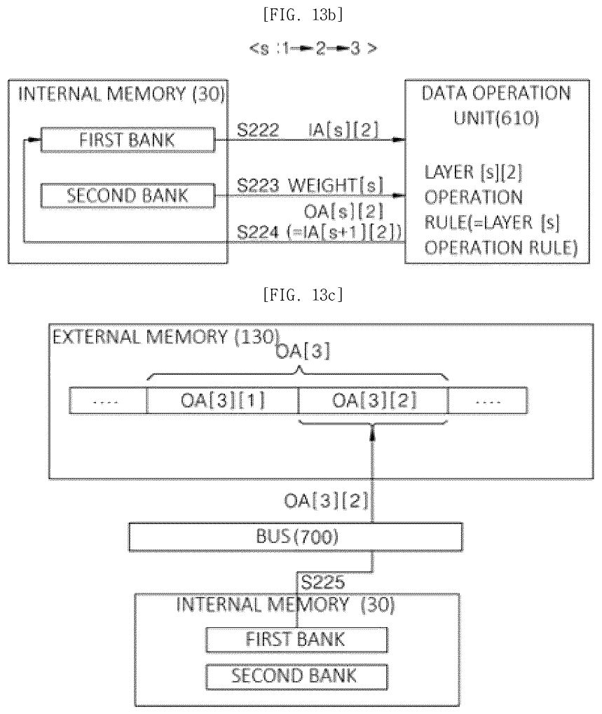

FIG. 12a, FIG. 12b, FIG. 12c, FIG. 13a, FIG. 13b, and FIG. 13c illustrate a method of performing a neural network operation on a user computing device of FIG. 2 according to an embodiment of the present invention.

Hereinafter, FIG. 12a, FIG. 12b, and FIG. 12c may be collectively referred to as FIG. 12, and FIG. 13a, FIG. 13b, and FIG. 13c may be collectively referred to as FIG. 13.

The process of generating the output activation OA[3] based on the input activation IA[1] illustrated in FIG. 10b or FIG. 10d is explained using FIG. 12 and FIG. 13.

Here, the input activation IA[1] may be divided into an input activation IA[1][1] and ab input activation IA[1][2] based on the row.

In FIG. 12, a reference symbol s is provided, and steps S210 to S215 are provided.

In step S210, the control unit 40 and the DMA unit 20 may read the weights [s] to be used for the operation rules of the layers included in the network N[1] of FIG. 10d from the external memory 130 through the bus 700 and store the weights [s] in the second bank of the internal memory 30 (s=1, 2, 3).

If weights are not used in the operation rules for at least some of the operation rules of the layers included in the network N[1], the corresponding weights may not be read from the external memory 130. In an embodiment, step S210 may not be necessary.

In step S211, the control unit 40 and the DMA unit 20 may read the input activation IA[1][1], which is a part of the input activation IA[1], from the external memory 130 through the bus 700 and store the input activation IA[1][1] in the first bank of the internal memory 30.

In this case, the size of the first bank may be smaller than the size of the entire input activation IA[1] and larger than the size of the input activation IA[1][1].

In FIG. 12b, if the reference symbol s is set to 1 and steps S212 to S214 are executed, the output activation OA[1][1] of FIG. 10d may be generated and stored in the first bank of the internal memory 30.

In FIG. 12b, if the reference symbol s is set to 2 and steps S212 to S214 are executed, the output activation OA[2][1] of FIG. 10d may be generated and stored in the first bank of the internal memory 30.

In FIG. 12b, if the reference symbol s is set to 3 and steps S212 to S214 are executed, the output activation OA[3][1] of FIG. 10d may be generated and stored in the first bank of the internal memory 30.

While sequentially changing the reference numeral s to 1, 2, and 3, the bus 700 is not used or the external memory 130 is not accessed while repeatedly executing steps S212 to S214.

Hereinafter, steps S212 to S214 will be described in detail.

In step S212, the control unit 40 may provide the input activation IA[s][1] stored in the first bank to the data operation unit 610.

In step S213, the control unit 40 may provide the weight [s] stored in the second bank to the data operation unit 610.

In step S214, the data operation unit 610 may generate the output activation OA[s][1] based on the input activation IA[s][1] and the weight [s] according to the operation rule of the layer [s][1], and the control unit 40 may store the output activation OA[s][1] in the first bank. In this case, the operation rule of layer [s][1] may be the same as the operation rule of layer [s].

In FIG. 12c, in step S215, the control unit 40 and the DMA unit 20 may store the output activation OA[3][1] in the external memory 130 through the bus 700.

In FIG. 13, a reference symbol s is presented, and steps S221 to S225 are presented.

FIG. 12 is a process of generating the output activation OA[3][1] from the input activation IA[1][1] of FIG. 10d and storing the activation OA[3][1] in the external memory 130, and FIG. 13 is a process of generating an output activation OA[3][2] from the input activation IA[1][2] of FIG. 10d and storing the output activation OA[3][2] in the external memory 130. When the output activation OA[3][1] is combined with the output activation OA[3][2], the output activation OA[3] of FIG. 10d may be obtained.

In step S221, the control unit 40 and the DMA unit 20 may read the input activation IA[1][2], which is the remaining part of the input activation (IA[1]), from the external memory 130 through the bus 700 and store read the input activation IA[1][2] in the first bank of the internal memory 30.

In this case, the size of the first bank may be smaller than the size of the entire input activation IA[1] and larger than the size of the input activation IA[1][2].

In FIG. 13b, when the reference symbol s is set to 1 and steps S222 to S224 are executed, the output activation OA[1][2] of FIG. 10d may be generated and stored in the first bank of the internal memory 30.

In FIG. 13b, when the reference symbol s is set to 2 and steps S222 to S224 are executed, the output activation OA[2][2] of FIG. 10d may be generated and stored in the first bank of the internal memory 30.

In FIG. 13b, when the reference symbol s is set to 3 and steps S222 to S224 are executed, the output activation OA[3][2] of FIG. 10d may be generated and stored in the first bank of the internal memory 30.

While sequentially changing the reference symbol s to 1, 2, and 3, the bus 700 is not used or the external memory 130 is not accessed while repeatedly executing steps S222 to S224.

Step S222 to step S224 will be described in detail.

In step S222, the control unit 40 may provide the input activation IA[s][2] stored in the first bank to the data operation unit 610.

In step S223, the control unit 40 may provide the weight [s] stored in the second bank to the data operation unit 610.

In step S224, the data operation unit 610 may generate the output activation OA[s][2] based on the input activation IA[s][2] and the weight [s] according to the operation rule of the layer [s][2], and the control unit 40 may store the output activation OA[s][2] in the first bank. In this case, the operation rule of layer [s][2] may be the same as the operation rule of layer [s].

In FIG. 13c, in step S225, the control unit 40 and the DMA unit 20 may store the output activation OA[3][2] in the external memory 130 through the bus 700.

FIG. 14 is a diagram illustrating a neural network operation method provided according to an embodiment of the present invention.

Referring to FIG. 14, the neural network operation method provided according to an embodiment of the present invention may include steps S1 to S5.

In step S1, the control unit 40 and the DMA unit 20 may read an input activation IA[1][p] (=input activation IA[s=1][p]) from the external memory 130 through the bus and store the input activation IA[1][p] in the internal memory 30.

In step S2, the data operation unit 610 may produce the output activation OA[1][p] based on the input activation IA[1][p] stored in the internal memory 30 according to the operation rule OR[1] of the layer L[1][p], and the control unit 40 may store the output activation OA[1][p] in the internal memory 30.

In step S3, the data operation unit 610 may produce the output activation OA[2][p] based on the output activation OA[1][p] stored in the internal memory 30 according to the operation rule OR[2] of the layer L[2][p], and the control unit 40 may store the output activation OA[2][p] in the internal memory 30.

In step S4, the data operation unit 610 may produce the output activation OA[3][p] based on the output activation OA[2][p] stored in the internal memory 30 according to the operation rule OR[3] of the layer L[3][p], and the control unit 40 may store the output activation OA[3][p] in the internal memory 30.

In step S5, the control unit 40 and the DMA unit 20 may store the output activation OA[3][p] (=output activation [s=3][p]) in the external memory 130 through the bus.

Here, the input activation IA[1] may be divided into a total of P portions, and the input activation IA[1][p] may be a part of the input activation IA[1].

Here, the operation rule of the layer [s][p] may be the same as the operation rule of the layer [s].

If steps S1 to S5 are repeatedly executed P times for p=1, . . . , P, the output activation OA[3] of the layer L[3] generated by the operation rules of a series of layers L[1], L[2], and L[3] based on the input activation IA[1] may be completed.

In FIG. 14, for convenience of the description, the partial network PN[1][p] is illustrated as including three layers, but the number of layers included in the partial network PN[1][p] is not limited thereto.

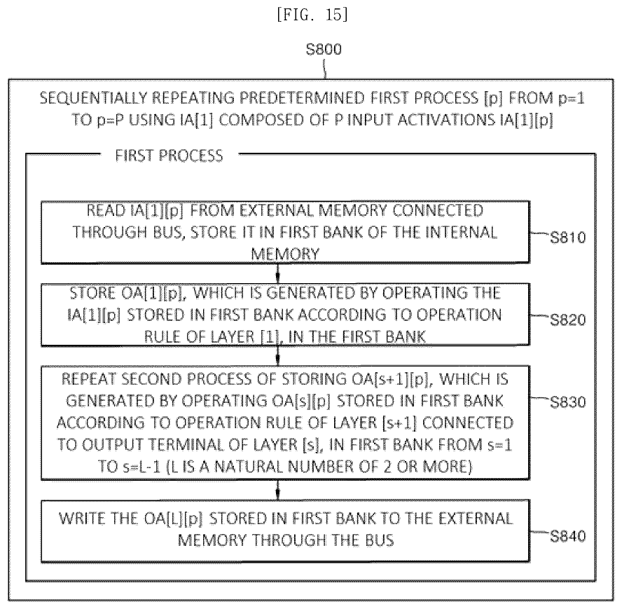

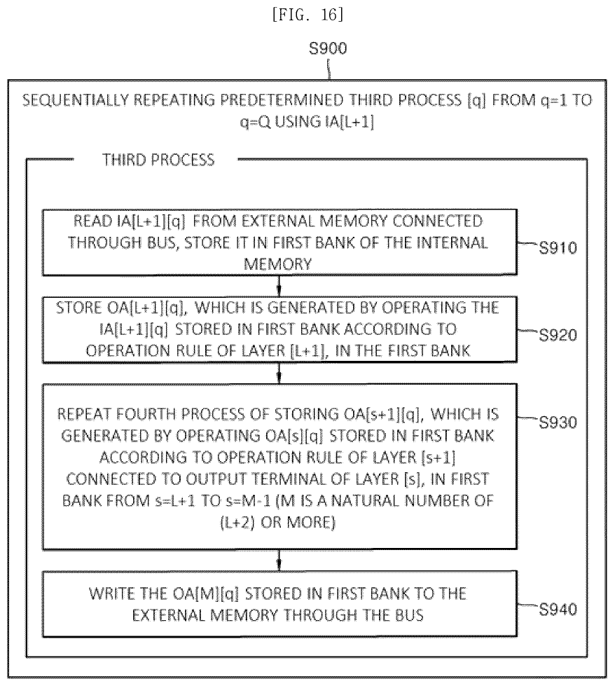

FIG. 15 and FIG. 16 are flowcharts illustrating a neural network operation method provided according to an embodiment of the present invention.

The above neural network operation method is a neural network operation method executed in the NPU 110 including the DMA unit 20, the internal memory 30, the data operation unit (operation device) 610, and the control unit 40. The above NPU 110 may be included in the user computing device 1 including the main processor 160, the external memory DRAM 130, the bus 700, and other hardware 99.

The neural network operation method may include a step S800 of sequentially repeating, by the NPU, a predetermined first process [p] from p=1 to p=P (p=1, . . . , P, P is a natural number of 2 or more) using an input activation IA[1] composed of P input activations IA[1][p] divided by rows or columns,.

In this case, the first process [p] may include the following steps.

In step S810, The DMA unit 20 and the control unit 40 may read the input activation IA[1][p] from the external memory 130 connected through the bus 70 and store the input activation IA[1][p] in the first bank of the internal memory 30.

In step S820, the control unit 40 may store the output activation OA[1][p], which is generated by performing an operation on the input activation IA[1][p] stored in the first bank according to the operation rule of the layer [1], in the first bank.

In step S830, the control unit 40 may sequentially repeat the second process of storing the output activation OA[s+1][p], which is generated by performing an operation on the output activation OA[s][p] stored in the first bank according to the operation rule of the layer [s+1] connected to the output terminal of the layer [s], in the first bank from s=1 to s=L−1 (L is a natural number of 2 or more).

In step S840, the DMA unit 20 and the control unit 40 may write the output activation OA[L][p] stored in the first bank to the external memory 130 through the bus 700.

In this case, the layer [1] and the layer [s+1] (s=1, . . . L−1) may be included in the neural network.

Also, the input activation IA[1] may be an input activation input to the layer [1] of the neural network.

The input activation IA[1] may be a tensor including a plurality of rows.

In this case, the neural network operation method may further include a step S790 of reading a weight [1] used for the operation rule of the layer [1] and a weight [s] (s=1, . . . , L−1) used for the operation rule of the layer [s] from the external memory 130 through the bus 700 and storing the read weights in the second bank of the internal memory 30, by the DMA unit 20 and the control unit 40, before the step S800 of sequentially repeating the first process [p].

In an embodiment, the output activation OA[1][p] may be generated based on the input activation IA[1][p] stored in the first bank and the weight [1] stored in the second bank, and the output activation OA[s+1][p] may be generated based on the output activation OA[s][p] stored in the first bank and the weight [s] stored in the second bank (s=1, . . . L−1).

In this case, the NPU may include a command file having a command code that causes the step S790 and the step S800 to be executed.

After the step of repeating the first process [p], information about the address of the external memory where the output activation OA[L][p] (p=1, . . . , P) is written may already be written in the command file used by the NPU.

In the step S800 described above, the activation composed of the output activations OA[L][p] (p=1, . . . , P) may be an input activation IA[L+1] input to the layer [L+1]. In this case, the input activation IA[L+1] may be divided into Q input activations IA[L+1][q] divided by rows or columns (q=1, . . . , Q, Q is a natural number of 2 or more).

According to an embodiment of the present invention, the neural network operation method may further include, after the step S800 of repeating the first process [p] as shown in FIG. 16, step S900 of sequentially repeating a predetermined third process [q] from q=1 to q=Q using the input activation IA[L+1].

In this case, the third process [q] may include the following steps.

In step S910, the DMA unit 20 and the control unit 40 may read the input activation IA [L+1][q] from the external memory 130 connected through the bus 700 and store the input activation IA[L+1][q] in the first bank of the internal memory.

In step S920, the control unit 40 may store the output activation OA[L+1][q], which is generated by performing an operation on the input activation IA[L+1][q] stored in the first bank according to the operation rule of layer [L+1], in the first bank.

In step S930, the control unit 40 may sequentially repeat, from s=L+1 to s=M−1 (M is a natural number of (L+2) or more), the fourth process of storing the output activation OA[s+1][q], which is generated by performing an operation on the output activation OA[s][q] stored in the first bank according to the operation rule of the layer [s+1] connected to the output terminal of the layer [s], in the first bank.

In step S940, the DMA unit 20 and the control unit 40 may write the output activation OA[M][q] stored in the first bank to the external memory 130 through the bus 700.

In this case, the layer [L+1] and the layer [s+1] (s=L+1, . . . , M−1) may be included in the neural network.

By using the embodiments of the present invention described above, those within the technical field of the present invention will be able to easily make various changes and modifications thereto within the scope not deviating from the essential characteristics of the present invention. The content of each claim in the patent claims may be combined with other claims that do not have a citation relationship within the scope that can be understood through this specification.

### Acknowledgement

The present invention was derived with the support of the following national research and development projects. [Project Identification Number] 2002, [Project Number] 20-CM-BD-02, [Ministry Name] Ministry of Trade, Industry and Energy, [Project Management (Special) Agency Name] Agency for Defense Development, Civil-Military Cooperation Promotion Agency, [Research Project Name] Civil-Military Dual-Use Technology Development Project, [Research Project Name] Development of AI Accelerator (NPU) during Edge SoC and Middleware Development for Semantic Information Processing from Acquired Images, [Contribution Rate] 1/1, [Project Executing Agency Name] Open Edge Technology Co., Ltd., and [Research Period] Dec. 24, 2020-Dec. 23, 2023

1. A method of creating an NPU command, comprising:
generating, by a computing device, a p-th partial network having the same structure as a structure of a first network defined by a first group of layers included in a predefined neural network;
determining, by the computing device, in a first memory included in another computing device, a p-th read address, which is a location of an address where a p-th partial input activation, which is data to be input to an uppermost layer of the p-th partial network, is stored;
determining, by the computing device, in the first memory, a p-th write address, which is a location of an address where a p-th partial output activation, which is data output by a lowermost layer of the p-th partial network, is to be stored; and
generating, by the computing device, an NPU command [p] including a first command set, a second command set, and a third command set,
wherein the first combination set includes commands for causing an NPU included in the other computing device to read the P-th partial input activation from the first memory based on the P-th read address and store the P-th partial input activation in an internal memory of the NPU,
the second command set includes commands for causing the NPU to generate the p-th partial output activation based on the p-th partial input activation stored in the internal memory, and
the third command set includes commands for causing the NPU to store the p-th partial output activation in the first memory based on the p-th write address.

2. The method of claim 1, wherein the first memory is a memory provided outside the NPU,
the p-th partial input activation is configured to be transferred from the first memory to the internal memory of the NPU through a bus of the other computing device, and
the p-th partial output activation is configured to be transferred from the internal memory to the first memory through the bus.

3. The method of claim 1, wherein the p-th partial output activation is generated by performing operation on the p-th partial input activation stored in the internal memory based on operation rules of layers included in the p-th partial network.

4. The method of claim 1, wherein the generating of the p-th partial network comprises:
defining, by the computing device, the first group composed of a plurality of consecutive layers included in a predefined neural network;
generating, by the computing device, structure information about the first network composed of a plurality of layers included in the defined first group and a plurality of links; and
generating, by the computing device, the p-th partial network having the same structure as the first network, and
the structure information about the first network is information about layers constituting the first group, operation rules of the layers, and links indicating activation movement paths between the layers.

5. The method of claim 1, wherein the first group comprises a plurality of layers,
the uppermost layer is a layer of the plurality of layers that receives an activation from outside the first group, and
the lowermost layer is a layer of the plurality of layers that provides an activation to outside the first group.

6. The method of claim 1, wherein the p-th partial input activation is a part of an input activation to be input to an uppermost layer among the first group of the layers.

7. A method of creating an NPU command, comprising:
generating, by a computing device, a partitioned network including a p-th partial network based on a first network composed of a first group of layers included in a predefined neural network (p is 1, 2, , and P); and
generating, by the computing device, an NPU command [p] that is configured to be executed by an NPU included in another computing device with respect to the p-th partial network (p is 1, 2, , or P),
wherein the generating of the partitioned network comprises:
defining, by the computing device, a p-th slice layer configured to receive an input activation to be input to the first group and output a partial input activation that is a part of the input activation (p is 1, 2, , and P);
defining, by the computing device, a p-th partial network that receives a p-th partial input activation output from the p-th slice layer (p is 1, 2, , and P);
defining, by the computing device, a concatenation layer that combines P partial output activations output from the P partial networks to each other; and
completing, by the computing device, the partitioned network by defining a plurality of links indicating activation movement paths between the P slice layers, the P partial networks, and the concatenation layer.

8. The method of claim 7, wherein the p-th partial input activation is a part of an input activation configured to be input to an uppermost layer among the first group of the layers, and
the input activation is restored using the first partial input activation to the P-th partial input activation.

9. The method of claim 7, wherein a structure of the p-th partial network is the same as a structure of the first network (p is 1, 2, , and P),
the generating of the NPU command [p] comprises:
determining, by the computing device, in a first memory included in another computing device, a p-th read address, which is a location of an address where a p-th partial input activation, which is data to be input to an uppermost layer of the p-th partial network, is stored;
determining, by the computing device, in the first memory, a p-th write address, which is a location of an address where a p-th partial output activation, which is data output by a lowermost layer of the p-th partial network, is to be stored; and
generating, by the computing device, an NPU command [p] including a first command set, a second command set, and a third command set,
the first command set includes commands for causing the NPU to read the P-th partial input activation from the first memory based on the P-th read address and store the P-th partial input activation in an internal memory of the NPU,
the second command set includes commands for causing the NPU to generate the p-th partial output activation based on the p-th partial input activation stored in the internal memory, and
the third command set includes commands for causing the NPU to store the p-th partial output activation in the first memory based on the p-th write address.

10. The method of claim 9, wherein the first memory is a memory provided outside the NPU,
the p-th partial input activation is configured to be transferred from the first memory to the internal memory of the NPU through a bus of the other computing device, and
the p-th partial output activation is configured to be transferred from the internal memory to the first memory through the bus.

11. The method of claim 7, wherein the generating of the p-th partial network comprises:
defining, by the computing device, the first group composed of a plurality of consecutive layers included in a predefined neural network;
generating, by the computing device, structure information about the first network composed of a plurality of layers included in the defined first group and a plurality of links; and
generating, by the computing device, the p-th partial network having the same structure as the first network,
the structure information about the first network is information about layers constituting the first group, operation rules of the layers, and links indicating activation movement paths between the layers.

12. A computing device comprising:
a storage unit; and
a main processor,
wherein, in the storage unit, a program comprising commands that cause the main processor to execute:
generating a p-th partial network having the same structure as a structure of a first network defined by a first group of layers included in a predefined neural network;
determining, in a first memory included in another computing device, a p-th read address, which is a location of an address where a p-th partial input activation, which is data to be input to an uppermost layer of the p-th partial network, is stored;
determining, in the first memory, a p-th write address, which is a location of an address where a p-th partial output activation, which is data output by a lowermost layer of the p-th partial network, is to be stored; and
generating an NPU command [p] including a first command set, a second command set, and a third command set, is written,
the first command set includes commands for causing an NPU included in the other computing device to read the P-th partial input activation from the first memory based on the P-th read address and store the P-th partial input activation in an internal memory of the NPU,
the second command set includes commands for causing the NPU to generate the p-th partial output activation based on the p-th partial input activation stored in the internal memory, and
the third command set includes commands for causing the NPU to store the p-th partial output activation in the first memory based on the p-th write address.

13. A computing device comprising:
a storage unit; and
a main processor,
wherein, in the storage unit, a program comprising commands that cause the main processor to execute:
generating a partitioned network including a p-th partial network based on a first network composed of a first group of layers included in a predefined neural network (p is 1, 2, , and P); and
generating an NPU command [p] that is configured to be execute by an NPU included in another computing device with respect to the p-th partial network (p is 1, 2, , or P), is written, and
the generating of the partitioned network comprises:
defining, by the computing device, a p-th slice layer configured to receive an input activation to be input to the first group and output a partial input activation that is a part of the input activation (p is 1, 2, , and P);
defining, by the computing device, a p-th partial network that receives a p-th partial input activation output from the p-th slice layer (p is 1, 2, , and P);
defining, by the computing device, a concatenation layer that combines P partial output activations output from the P partial networks to each other; and
completing, by the computing device, the partitioned network by defining a plurality of links indicating activation movement paths between the P slice layers, the P partial networks, and the concatenation layer.
